(19) United States
(12) Patent Application Publication
(10) Pub. No.: US 2018/0038706 A1
(43) Pub. Date: Feb. 8, 2018

(54) Modal Transit Schema Based on Available Time, Transit Type, Selected Interests and Environmental Factors

(71) Applicant: Civic Resource Group International, Inc., LOS ANGELES, CA (US)

(72) Inventors: Peter Malcolm Ellenby, Portland, OR (US); Thomas William Ellenby, San Jose, CA (US); Roderick Perkins, Menlo Park, CA (US); Matthew Wong, Palo Alto, CA (US); John Ellenby, SAN FRANCISCO, CA (US)

(21) Appl. No.: 15/666,883

(22) Filed: Aug. 2, 2017

Related U.S. Application Data
(60) Provisional application No. 62/371,277, filed on Aug. 5, 2016.

(51) Int. Cl. G01C 21/34; G01C 21/36; G06F 17/30

(52) U.S. Cl. CPC G01C 21/3484; G06F 17/30241; G06F 17/3087; G01C 21/3423; G01C 21/3667

(57) ABSTRACT

A computer system and associated methods performed by the computer system creates routes, optionally including differing types of transit, based on one or more of a traveler's allotted time to arrive at a destination, the traveler's reason or purpose for a trip and the traveler's selected interests or environmental factors that may affect or alter the traveler's journey. Using user preferences and pre-set thresholds related to specific types of points of interest or geolocated object a route from a start location to a desired destination is created to achieve a desired arrival time while optionally including various proposed combinations of additional stops and/or a transit types.

### RELATED APPLICATIONS

The subject matter of this application is related to U.S. Provisional Application No. 62/371,277, filed on Aug. 5, 2016 which application is incorporated herein by reference.

### BACKGROUND

When one uses a web service or an app, such as Bing maps or the Bay Area's 511 service, to find public transit directions and routes the result(s) given is the fastest and most direct route, which may include elements such as driving or walking to get to the station or stop where the trip originates from, transfers between stations or stops to change from one mode of transport to another along the route and potentially the final walking leg of the route from the last transport station or stop to the desired destination. The time of day and date of the trip can be added but the route or routes suggested will usually be the same. There is no way to add interests such as “scenic route” or “architecture” to the suggested routes, and no ability to let the routing system know that you may not be in a huge rush and would like to perhaps stroll through an historic part of town and have time for a meal along the way to your destination. It also doesn't take into account the weather or general safety of a neighborhood when suggesting routes that may have a large amount of walking.

### SUMMARY

Systems and methods in accordance with various embodiments relate to modifying routes or selecting differing types of transit based on a traveler's allotted time to arrive at a destination, their reason or purpose for the trip and on selected interests or environmental factors that may affect or alter their journey. Given system knowledge of a user of the systems preferences and pre-set thresholds related to specific types of points of interest or geolocated objects, a route from a user of the systems current location to arrive at a desired destination at a desired time may be modified to include various combinations of additional stops and/or a transit types.

A computer system and associated methods performed by the computer system creates routes, optionally including differing types of transit, based on one or more of a traveler's allotted time to arrive at a destination, the traveler's reason or purpose for a trip and the traveler's selected interests or environmental factors that may affect or alter the traveler's journey. Using user preferences and pre-set thresholds related to specific types of points of interest or geolocated object a route from a start location to a desired destination is created to achieve a desired arrival time while optionally including various proposed combinations of additional stops and/or a transit types.

In one embodiment, a method for generating a travel route includes: receiving a travel routing request, wherein the request comprises a specification of a destination and an arrive by time or maximum travel duration; determining a starting location; querying a database of locations to identify a candidate set of one or more intermediate stop locations; for each of a plurality of combinations of one or more of the set of intermediate stop locations, and for each of one or more permutations of the each combination of one or more intermediate stop locations: determining a route from the starting location to the destination, passing through the permutation of the each combination of one or more intermediate stop locations, determining a predicted arrival time or a predicted duration for traversing the route, comparing the predicted arrival time to the arrive by time or comparing the predicted duration to the maximum travel duration, and determining whether to present the permutation in a user interface based on the comparison.

In one aspect, the predicted arrival time or duration for traversing the route accounts for stopover times at the one or more intermediate stop locations.

In one aspect, the database is queried based on a saved user profile.

In one aspect, the saved user profile specifies a set of one or more location preferences, and wherein the database is queried based on the one or more location preferences.

In one aspect, the saved user profile specifies a set of one or more transit type preferences, and wherein the route is determined based on the set of one or more transit type preferences.

In one aspect, the travel routing request comprises an arrive by time, wherein the determining is of a predicted arrival time, and wherein the comparing is of the predicted arrival time to the arrive by time.

In one aspect, the comparing the predicted arrival time to the arrive by time comprises determining whether the predicted arrival time is earlier than the arrive by time by at least a predetermined threshold.

In one aspect, the method further includes determining a start time, wherein the determining a predicted arrival time is based on the start time.

In one aspect, the travel routing request further comprises a specification of the start time.

In one aspect, the travel routing request further comprises a specification of the starting location.

In one aspect, the travel routing request comprises a maximum travel duration, wherein the determining is of a predicted duration, and wherein the comparing is of the predicted duration to the maximum travel duration.

In one aspect, the comparing the predicted duration to the maximum travel duration comprises determining whether the predicted duration is less than the maximum travel duration by at least a predetermined threshold.

In one aspect, the method further includes determining a start time, wherein the determining a predicted duration is based on the start time.

In one embodiment, a method for generating a travel route includes: receiving a travel routing request, wherein the request comprises a specification of: a travel time specified by at least two of: a start time, an arrival time, and a travel duration, and a destination location; determining a starting location; querying a database of locations to identify a candidate set of one or more intermediate stop locations; for each of a plurality of combinations of one or more of the set of intermediate stop locations, and for each of one or more permutations of the each combination of one or more intermediate stop locations: determining a route from the starting location to the destination, passing through the permutation of the each combination of one or more intermediate stop locations, determining a predicted arrival time or a predicted duration for traversing the route, comparing the predicted arrival time to the arrival time or comparing the predicted duration to the travel duration, and determining whether to present the permutation in a user interface based on the comparison.

In one aspect, the travel routing request further comprises a specification of the starting location.

In one aspect, the determining a predicted duration is based on the start time.

In one aspect, the arrival time is a desired latest arrival time.

In one aspect, the travel duration is a desired maximum travel duration.

In one aspect, the database is queried based on a saved user profile.

In one aspect, the saved user profile specifies a set of one or more location preferences, and wherein the database is queried based on the one or more location preferences.

In one embodiment, a system includes a computer processor and memory, wherein the memory is encoded with instructions that, when executed by the computer processor, cause the computer processor to perform any of the foregoing methods.

In one embodiment, a non-transitory computer-readable medium includes instructions that, when executed by a computer processor, cause the computer processor to perform any of the foregoing methods.

### BRIEF DESCRIPTION OF THE DRAWINGS

FIG. 1 is a flowchart illustrating a possible mode of operation of a system in accordance with one embodiment.

FIG. 2 is a flowchart illustrating a possible mode of operation of a system in accordance with one embodiment.

FIG. 3 is a flowchart illustrating a possible mode of operation of a system in accordance with one embodiment.

FIG. 4 is a flowchart illustrating a possible mode of operation of a system in accordance with one embodiment.

FIG. 5 is a flowchart illustrating a possible mode of operation of a system in accordance with one embodiment.

FIG. 6 is a route example diagram of a multiple transit type journey with “Tourist Mode” selected.

FIG. 7 illustrates an example computer.

### DETAILED DESCRIPTION

In the following description, references are made to various embodiments in accordance with which the disclosed subject matter can be practiced. Multiple references to “one embodiment” or “an embodiment” do not necessarily refer to the same embodiment. Particular features, structures or characteristics associated with such embodiments can be combined in any suitable manner in various embodiments. References are also made to the accompanying drawings in which the same reference numbers are used throughout to refer to the same or like components.

It will be appreciated that each of the embodiments described include methods and that the methods of one embodiment may be different than the methods of another embodiment. The embodiments described herein set forth certain methods for providing unique experiences to users of the system.

It should also be noted that the embodiments described herein can operate on several platforms including but not limited to laptop computers, desktop computers, smart-phones and tablets and also run on a variety of application types including but not limited to internet browsers and stand-alone custom applications.

The system described herein may use, but is not limited to, the following as modifiers to a desired public transit or other route;

Transit Types: Rail or light rail, Street cars, Busses, Pedi-cabs, Taxis or hired cars, Walking, Ferries, Bike, Bike Share, Car Share, Personal car or motorcycle—this may also involve the use of commuter parking lots.

Modes: Fastest, Cheapest, Tourist, Exercise, Leisure, Safety and avoidance, Scenic or Photographic, Quiet (off the beaten path and no main roads), Non-Crowded or Crowded, Errands, Needs & Daily Routine, Bike Friendly, New and Non-Repeat Journey.

Interests: Nature, Architecture, History and subcategories; homes of the stars, military et., Food—Categories and Cost, Coupon or Discount Code Available, Drink—Categories and Cost, Coupon or Discount Code Available, Coffee—Coupon or Discount Code Available, Dog Friendly, Recreation—jogging path for example, Geo-locational gaming opportunities, scavenger hunts etc., Culture—Categories and Cost, Coupon or Discount Code Available, Entertainment—Categories and Cost, Coupon or Discount Code Available, Shopping & sub genres; clothes, books etc. & available coupons or discounts, Art & Public Art, Meeting people or picking people up along the route.

Environmental Modifiers: Weather & Weather Forecast, Terrain and elevation changes, Time of day, Season, Local events such as sports, parades and fairs that may increase load on a transit system alter or block routes, Construction and road work, Event type (if any) at destination, Desired time to spend at a location for a specific activity, Hours of operations for a given venue, Transit schedule at the approximate time to leave for the next destination, Transit events, Congestion information, Amount of luggage or bags from shopping etc., Age of group, children or editors etc., General health of traveler(s), broken leg, wheelchair etc.

All of the above modifiers, when chosen by a user, could be stored as a user profile. A user may have several profiles that relate to different cites, times of day, or days of the week.

A computer server system, capable of aggregating data from content rich mapping sources (Google, Bing etc.), local and regional transit sources (Bay Area 511, Portland TriMet New York MTA etc.), crowdsourced data (Yelp, TripAdvisor etc.), social media (Facebook, Twitter, Snapchat etc.), weather sources, crime data, access to city web cams and smart monitoring devices such as smart street lamps etc., could be programmed to take all of these elements, as chosen by the user(s), or determined by a profile they had set up, into account when a user or users request a journey plan.

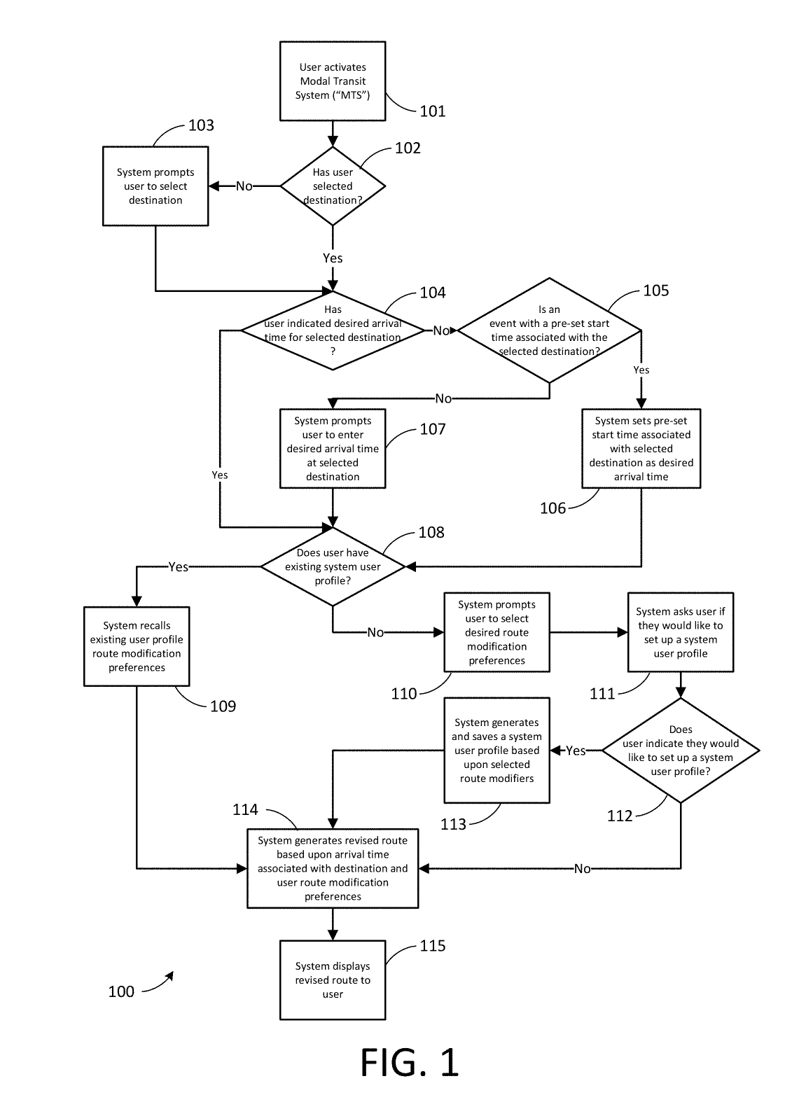

FIG. 1 is a flowchart 100 illustrating one possible basic mode of operation of a system in accordance with one embodiment. In step 101 a user of the system activates the Modal Transit System (“MTS”). The flowchart then branches to step 102. In step 102 the system determines if the user of the system has selected a destination. If the user of the system has selected a destination the flowchart branches to step 104. If the user of the system has not selected a destination the flowchart branches to step 103. In step 103 the user is prompted to select a destination. The flowchart then branches to step 104. In step 104 the system determines if a desired destination arrival time has been selected. If a desired destination arrival time has been selected the flowchart branches to step 108. If a desired destination arrival time has not been selected the flowchart branches to step 105. In step 105 the system determines if there is a pre-set start time of an event associated with the selected destination. Such an event may be, for example, a sporting event, flight departure, or other such event that has a hard start time. If the system determines that there is a pre-set start time of an event associated with the selected destination the flowchart branches to step 106. If the system determines that there is not a pre-set start time of an event associated with the selected destination the flowchart branches to step 107. In step 106 the system sets the pre-set start time of the event associated with the destination as the desired arrival time. It should be noted that the desired arrival time could then be modified by the user. For example, the user desires to arrive 30 minutes prior to the actual start time of the event and modifies the arrival time accordingly. This arrival time offset could also be part of a system user profile. The flowchart then branches to step 108. In step 107 the system prompts the user to enter a desired arrival time at the selected destination. The flowchart then branches to step 108. In step 108 the system determines if the current user has an existing system user profile. If the current user does have an existing system user profile the flowchart then branches to step 109. If the current user does not have an existing system user profile the flowchart then branches to step 110. In step 110 the system prompts the user to select the desired route modifiers. The flowchart then branches to step 111. In step 111 the system queries the user as to whether they would like to create a system user profile. The flowchart then branches to step 112. In step 112 the system determines if the user would like to create a system user profile. If the user has indicated that they would like to create a system user profile the flowchart branches to step 113. If the user has indicated that they would not like to create a system user profile the flowchart branches to step 114. In step 113 the system generates and saves a system user profile associated with the current user and based upon the selected route modifiers. The flowchart then branches to step 114. In step 109 the system recalls the current user's system user profile and the route modification preferences contained therein. The flowchart then branches to step 114. In step 114 the system generates a revised route from origin to desired destination based upon the desired arrival time and the route modification preferences. The flowchart then branches to step 115. In step 115 the revised route is displayed to the user of the system. It should be noted that while proceeding on the modified route the user of the system may deviate from the route, change preferences, or interact with points of interest included in the route and that these deviations, changes or interactions may cause the rout to be further modified and recalculated.

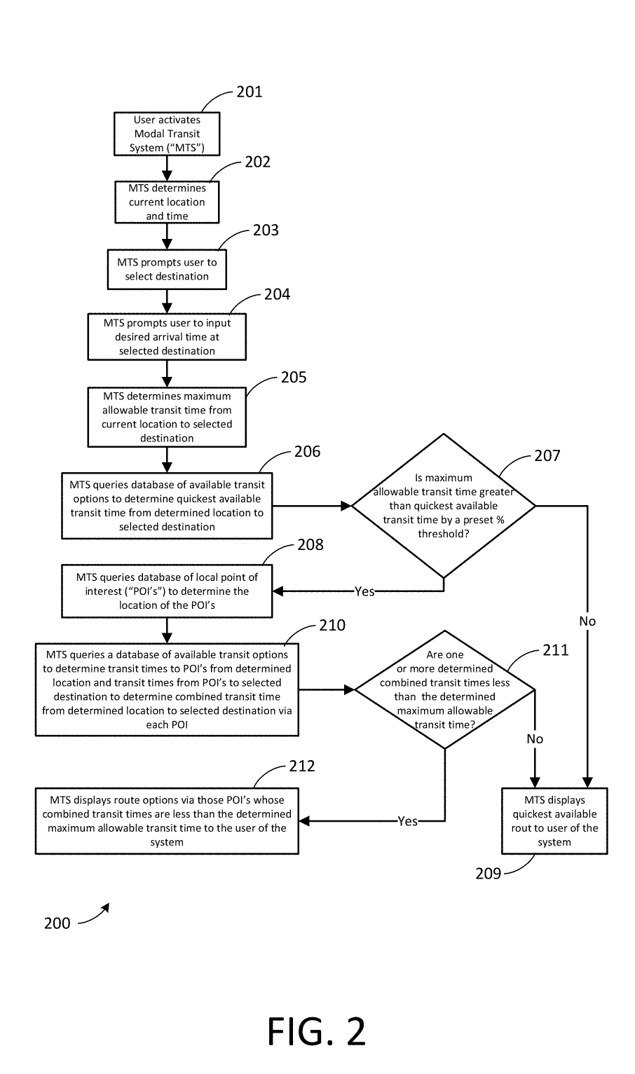

FIG. 2 is a flowchart 200 describing a basic mode of operation for one of the methods in accordance with one embodiment involving Points of interest (“POIs”). In step 201 the user of the system activates the Modal Transit System (“MTS”). The flowchart then branches to step 202. In step 202 the system determines its current location, i.e. its position. The flowchart then branches to step 203. In step 203 the system prompts the user to select a destination location. The flowchart then branches to step 204. In step 204 the system prompts the user to input a desired arrival time at the selected destination location. It should be noted that in an alternate version of this method the arrival time may be automatically set if an event known to the system with a pre-set start time, such as a ferry departure or kick-off of a sporting event for example, is taking place at the selected destination location. The flowchart then branches to step 205. In step 205 the system determines the maximum allowable transit time from the current determined location to the selected destination location by comparing the current time to the desired arrival time at the selected destination location. The flowchart then branches to step 206. In step 206 the system queries a database of available transit options to determine the option or options with the shortest transit time, i.e. the quickest, from the current determined location to the selected destination location. The flowchart then branches to step 207. In step 207 the system determines if the maximum allowable transit time as determined in step 205 is greater that the quickest available transit option as determined in step 306 by a preset threshold. This threshold may be a set time, e.g. 30 minutes, may be a preset percentage of the maximum allowable transit time, e.g. 40%, or may be based on other metrics. An example may be that the maximum allowable transit time is 1 hours and the quickest available transit option, in this case a ride-sharing hire car, will take 45 minutes. If the threshold was set at 30 minutes then this trip would qualify for further analysis by the MTS given that the time differential between the maximum allowable transit time and the quickest transit time is 1 hr 15 minutes and therefore well above the 30 min threshold. If the system determines that the maximum allowable transit time is not greater than the quickest available transit option by the preset threshold then the flowchart branches to step 209 in which the system displays the quickest available transit option to the user of the system. If the system determines that the maximum allowable transit time is greater than the quickest available transit option by the preset threshold then the flowchart branches to step 208. In step 208 the system queries a database of local POIs to determine the locations of the POIs. The flowchart then branches to step 210. In step 210 the system queries a database of available transit options to determine transit times to each POI from the determined location of the system and transit times from the location of each POI to the selected destination location to determine the combined transit time from the determined location of the system via the POI and thence to the selected destination location. The flowchart then branches to step 211. In step 211 the system determines if one or more of the determined combined transit times associated with the POIs is less than the determined maximum allowable transit time. If none of the combined transit times are less than the maximum allowable transit time then the flowchart branches to step 209 in which in which the system displays the quickest available transit option to the user of the system. If one or more of the combined transit times are less than the maximum allowable transit time then the flowchart branches to step 212. In step 212 the system displays the route options via those POIs whose combined transit times are less than the maximum allowable transit time to the user of the MTS. Note that the quickest available may also be displayed as an option.

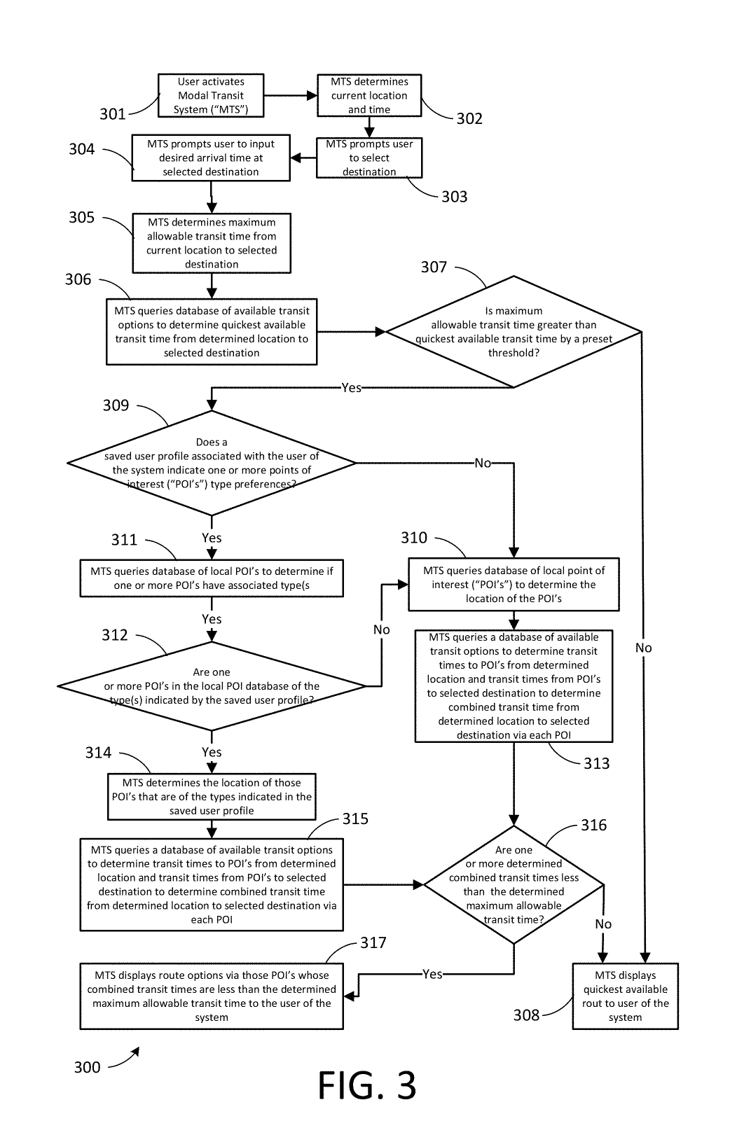

FIG. 3 is a flowchart 300 describing a basic mode of operation for one of the methods in accordance with one embodiment involving Points of interest (“POIs”). In step 301 the user of the system activates the Modal Transit System (“MTS”). The flowchart then branches to step 302. In step 302 the system determines its current location, i.e. its position. The flowchart then branches to step 303. In step 303 the system prompts the user to select a destination location. The flowchart then branches to step 304. In step 304 the system prompts the user to input a desired arrival time at the selected destination location. The flowchart then branches to step 305. In step 305 the system determines the maximum allowable transit time from the current determined location to the selected destination location by comparing the current time to the desired arrival time at the selected destination location. The flowchart then branches to step 306. In step 306 the system queries a database of available transit options to determine the option or options with the shortest transit time, i.e. the quickest, from the current determined location to the selected destination location. The flowchart then branches to step 307. In step 307 the system determines if the maximum allowable transit time as determined in step 305 is greater that the quickest available transit option as determined in step 306 by a preset threshold. If the system determines that the maximum allowable transit time is not greater than the quickest available transit option by the preset threshold then the flowchart branches to step 308 in which the system displays the quickest available transit option to the user of the system. If the system determines that the maximum allowable transit time is greater than the quickest available transit option by the preset threshold then the flowchart branches to step 309. In step 309 the system ascertains whether the user of the system has an associated user profile that indicates one or more type preferences for POIs. If the user of the system does not have a user profile that indicates POI type preference the flowchart branches to step 310. If the user of the system does have a user profile that indicates POI type preference the flowchart branches to step 311. In step 311 the system queries a database of local POIs to determine if one or more of the POIs in the database have an indicated type. The flowchart then branches to 312. In step 312 the system determines if one or more of the POIs in the local database are of the type(s) indicated by the user profile. If one or more of the POIs in the local database are not of the type(s) indicated by the user profile the flowchart then branches to step 310. If one or more of the POIs in the local database are of the type(s) indicated by the user profile the flowchart then branches to step 314. In step 310 the system queries a database of local POIs to determine the locations of the POIs. The flowchart then branches to step 313. In step 313 the system queries a database of available transit options to determine transit times to each POI from the determined location of the system and transit times from the location of each POI to the selected destination location to determine the combined transit time from the determined location of the system via the POI and thence to the selected destination location. The flowchart then branches to step 316. In step 314 the system queries a database of local POIs to determine the locations of those POIs that match the user profile defined type preferences. The flowchart then branches to step 315. In step 315 the system queries a database of available transit options to determine transit times to each type matching POI from the determined location of the system and transit times from the location of each POI to the selected destination location to determine the combined transit time from the determined location of the system via the POI and thence to the selected destination location. The flowchart then branches to step 316. In step 316 the system determines if one or more of the determined combined transit times associated with the POIs is less than the determined maximum allowable transit time. If none of the combined transit times are less than the maximum allowable transit time then the flowchart branches to step 308 in which in which the system displays the quickest available transit option to the user of the system. If one or more of the combined transit times are less than the maximum allowable transit time then the flowchart branches to step 317. In step 317 the system displays the route options via those POIs whose combined transit times are less than the maximum allowable transit time to the user of the MTS. Note that the quickest available may also be displayed as an option.

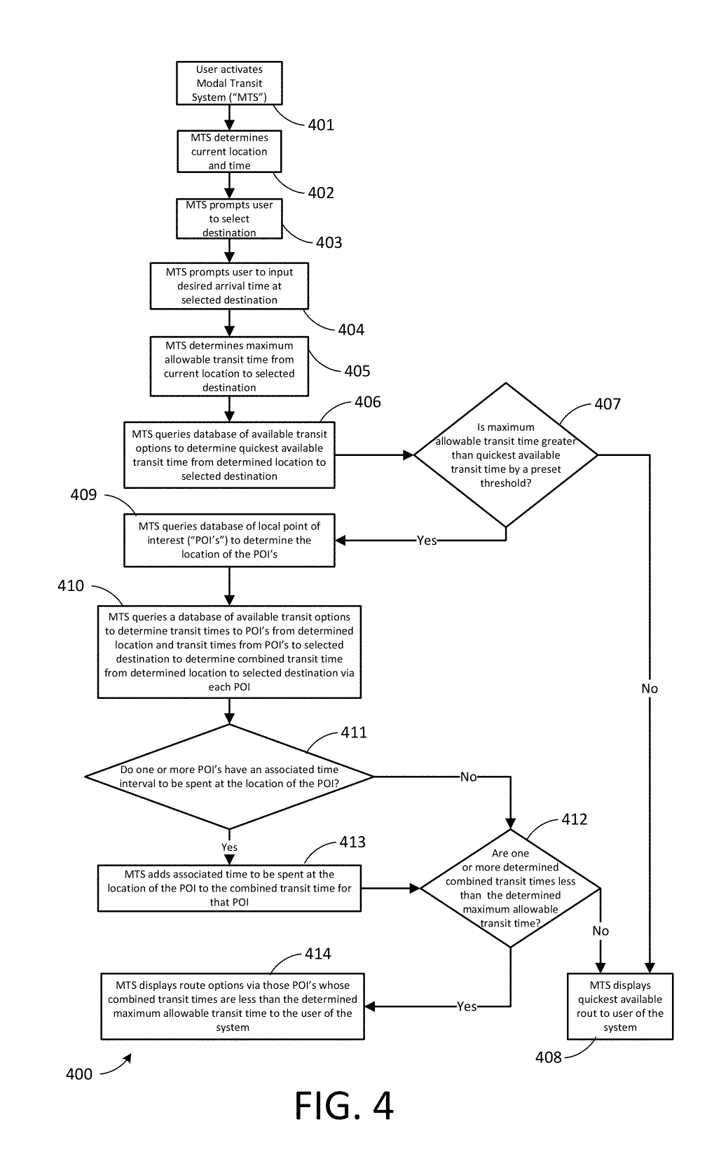

FIG. 4 is a flowchart 400 describing a basic mode of operation for one of the methods in accordance with one embodiment involving Points of interest (“POIs”). In step 401 the user of the system activates the Modal Transit System (“MTS”). The flowchart then branches to step 402. In step 402 the system determines its current location, i.e. its position. The flowchart then branches to step 403. In step 403 the system prompts the user to select a destination location. The flowchart then branches to step 404. In step 404 the system prompts the user to input a desired arrival time at the selected destination location. The flowchart then branches to step 405. In step 405 the system determines the maximum allowable transit time from the current determined location to the selected destination location by comparing the current time to the desired arrival time at the selected destination location. The flowchart then branches to step 406. In step 406 the system queries a database of available transit options to determine the option or options with the shortest transit time, i.e. the quickest, from the current determined location to the selected destination location. The flowchart then branches to step 407. In step 407 the system determines if the maximum allowable transit time as determined in step 405 is greater that the quickest available transit option as determined in step 506 by a preset threshold. This threshold may be a set time, e.g. 30 minutes, may be a preset percentage of the maximum allowable transit time, e.g. 40%, or may be based on other metrics. If the system determines that the maximum allowable transit time is not greater than the quickest available transit option by the preset threshold then the flowchart branches to step 408 in which the system displays the quickest available transit option to the user of the system. If the system determines that the maximum allowable transit time is greater than the quickest available transit option by the preset threshold then the flowchart branches to step 409. In step 409 the system queries a database of local POIs to determine the locations of the POIs. The flowchart then branches to step 410. In step 410 the system queries a database of available transit options to determine transit times to each POI from the determined location of the system and transit times from the location of each POI to the selected destination location to determine the combined transit time from the determined location of the system via the POI and thence to the selected destination location. The flowchart then branches to step 411. In step 411 the system determines if one or more POIs have an associated time interval to be spent at the location of the POI. An example of such a time interval may be 90 minutes to have a guided tour at the Museum of Modern Art. If one or more POIs does not have an associated time interval the flowchart branches to step 412. If one or more POIs does have an associated time interval the flowchart branches to step 413. In step 413 the system ads the time interval associated with a specific POI to the determined combined transit time for that POI. The flowchart then branches to step 412. In step 412 the system determines if one or more of the determined combined transit times associated with the POIs is less than the determined maximum allowable transit time. If none of the combined transit times are less than the maximum allowable transit time then the flowchart branches to step 408 in which in which the system displays the quickest available transit option to the user of the system. If one or more of the combined transit times are less than the maximum allowable transit time then the flowchart branches to step 414. In step 414 the system displays the route options via those POIs whose combined transit times are less than the maximum allowable transit time to the user of the MTS. Note that the quickest available may also be displayed as an option.

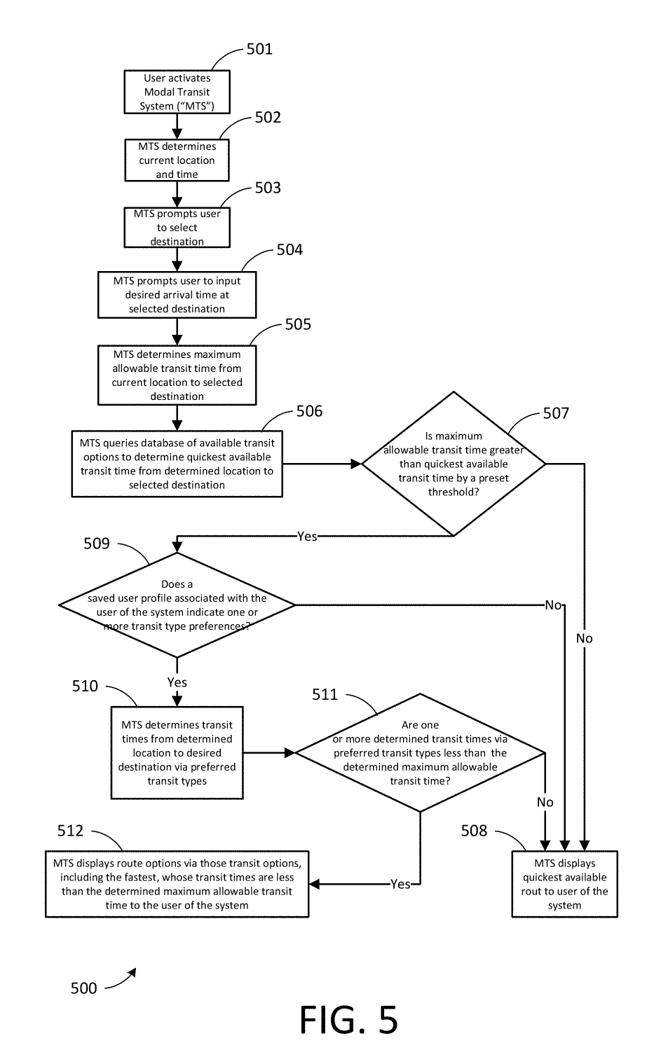

FIG. 5 is a flowchart 500 describing a basic mode of operation for one of the methods in accordance with one embodiment involving Points of interest (“POIs”). In step 501 the user of the system activates the Modal Transit System (“MTS”). The flowchart then branches to step 502. In step 502 the system determines its current location, i.e. its position. The flowchart then branches to step 503. In step 503 the system prompts the user to select a destination location. The flowchart then branches to step 504. In step 504 the system prompts the user to input a desired arrival time at the selected destination location. The flowchart then branches to step 505. In step 505 the system determines the maximum allowable transit time from the current determined location to the selected destination location by comparing the current time to the desired arrival time at the selected destination location. The flowchart then branches to step 506. In step 506 the system queries a database of available transit options to determine the option or options with the shortest transit time, i.e. the quickest, from the current determined location to the selected destination location. The flowchart then branches to step 507. In step 507 the system determines if the maximum allowable transit time as determined in step 505 is greater that the quickest available transit option as determined in step 506 by a preset threshold. If the system determines that the maximum allowable transit time is not greater than the quickest available transit option by the preset threshold then the flowchart branches to step 508 in which the system displays the quickest available transit option to the user of the system. If the system determines that the maximum allowable transit time is greater than the quickest available transit option by the preset threshold then the flowchart branches to step 509. In step 509 the system ascertains whether the user of the system has an associated user profile that indicates one or more transit type preferences. An example of such a preference may be that the user has indicated that they would like to walk on foot whenever possible. If the user of the system does not have a user profile that indicates transit type preference the flowchart branches to step 508 in which the system displays the quickest available transit option to the user of the system. If the user of the system does have a user profile that indicates transit type preference the flowchart branches to step 510. In step 510 the system determines the transit times from the determined location to the selected destination location via the transit types so indicated. The flowchart then branches to step 511. In step 511 the system determines if one or more determined transit times via the preferred transit types are less than the determined allowable maximum transit time. If one or more determined transit times via the preferred transit types are not less than the determined allowable maximum transit time the flowchart branches to step 508 in which the system displays the quickest available transit option to the user of the system. If one or more determined transit times via the preferred transit types are less than the determined allowable maximum transit time the flowchart branches to step 512. In step 512 the system displays the route options via those transit types whose transit times are less than the maximum allowable transit time to the user of the MTS. Note that the quickest available may also be displayed as an option.

For simplicity FIGS. 2-5 illustrate methods for modifying a route by adding one POI or selecting a different transit type but it should be appreciated that these methods may be extended, i.e. incorporating two or more POIs into the route, and/or combined, i.e. modifying the transit type for some or all of the legs to or from POIs to produce a more advanced version of a method in accordance with one embodiment.

In our first example, we have a traveler who is traveling from their home via the Bay Area Rapid Transit (BART) station in Colma, Calif., located in the East Bay, and would like to go to AT&T Park in San Francisco to see a baseball game that begins at 7:15 PM. They decide to use the Bay Area 511 transit website to get directions to the park. Upon entering the starting location, their home in Colma, and final destination of their route the traveler is offered the fastest way to the park, a combination of a quick drive to park in the BART station commuter lot, a BART train and a San Francisco Muni light rail train that will get him to the park in one hour and 15 minutes. Now comes the addition of the system described herein. The traveler has several options they can choose to modify the route based on their interests, time and other environmental modifiers. The traveler realizes it is quite early and has time for a bit of walking and a meal on their way to the game so they select the leisure and dining options for the route. The 511 system re-calculates a route for the user with just the BART ride to the Embarcadero station and a nice stroll along the picturesque San Francisco Embarcadero instead of the light rail leg of the trip. The 511 system also brings up a list of the restaurants and dining options along the walk (or close to the park since perhaps the desired restaurant may beyond the destination) and the traveler may select a restaurant as a stop (the system may even make a reservation for the traveler based on their estimated arrival time) or save the list and location of each option for access during the trip. If the user was using an app on a smart-phone or tablet to set their journey they would be guided along by the app as the route progressed. Once the game is over the system reverses the route for the user, taking into account that the commuter garage at the BART station in Colma closes at 1 AM and the system would therefore ensure that they arrived back at the station before the lot is locked for the night.

In the next example of the system we have the same traveler and the same start and end points for the journey although in this instance the start time of the journey is even earlier allowing them other options. They select leisure, culture, weather and terrain options for the journey. Under the terrain option they select limited incline and altitude changes for any walking sections of the trip. The system would then look for cultural destinations along or near the route and suggest them as stops for the user and also ensure that any walking needed between destinations was relatively flat. It would also check the weather and if any rain or other inclement weather such as excessive heat or cold was forecast along the route it may suggest an umbrella or other appropriate attire. The system may also ask if the user still wished to walk in those conditions and, if not, suggest other means of accomplishing the trip such as private cars or covered pedi-cabs that could be booked in advance. For this example, the weather that day is fine so walking will not be a problem. The system calculates that the user can take BART from Colma one stop further than the Embarcadero station to the Montgomery Street station in San Francisco and then have a short walk to the Contemporary Jewish Museum. Then another short walk to Yerba Buena Center for the Arts and then one more to the San Francisco Museum of Modern Art (SFMOMA). It is possible that the app may also allow the user to purchase admission tickets to all selected cultural stops on the route and suggest allotted time to spend in each destination so they are not late for the game. Once finished at the San Francisco Museum of Modern Art the system may calculate time available to the game and suggest the best means of getting there. It is also possible that other modifying selections such as food or drink may be added at this time, or at any other point in the journey. While engaging in activities along their journey the system may provide alerts, audible or haptic, about time left for a specific activity, and updated arrival time of trains and busses. These alerts may also inform a user about the availability of a coupon, a happy hour beginning or about the end at their desired dining or drinking establishment etc. It may also be the case that these alerts could be overridden by a user resulting in their trip being altered. For example they find themselves enjoying the Yerba Buena Center for the Arts so much they decide to not go to the SFMOMA and spend more time at Yerba Buena. The journey and route would be recalculated by the system to still allow an on time arrival at AT&T Park.

A further understanding may come from the next example. A traveler is staying at a hotel in the SOMA district of San Francisco, the Intercontinental San Francisco, at the corner of Howard and 5th Street. They have tickets to take the ferry from Pier 33 to the tour on Alcatraz Island National Park at 1:30 PM and need to arrive for boarding at 1:15 PM. It is now 11 AM and they are ready to go. A search for public transit directions on Google would have them take either a bus, or light rail and then a street car with both trips taking roughly 30-35 minutes. Realizing they have far more time than that to get to their destination the user selects tourist mode and the system recalculates a route that will allow them to experience some of San Francisco's best tourist spots and still allow them to arrive on time. They are then directed to take the #8 bus from the corner of 3rd and Howard streets and disembark the bus at the intersection of Pacific and Columbus streets. Once they get off the bus they could be directed by the compass in their mobile device to look southeast and view both the original and the new, and more famous, Transamerica buildings. They would then be directed on foot, guided by their mobile device, through historic North Beach and shown the sights within the neighborhood such as City Lights Books, Washington Square Park, Saints Peter and Paul Cathedral and a great view of Coit Tower. Also at any time the traveler could ask for a coffee, a bite to eat or a drink along the way and be given many options. The system would ensure that they still arrive at the ferry on time after a nice downhill walk on Stockton street to Pier 39 and then a short stroll east on the Embarcadero.

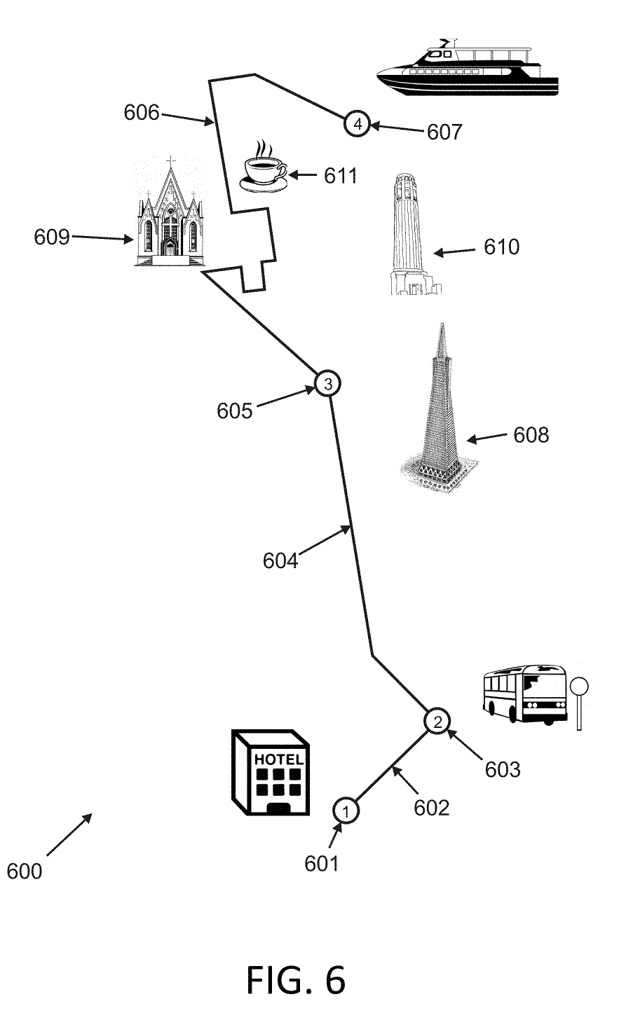

FIG. 6 is a plan/map view 600 of the above example of a multiple transit type route with “Tourist Mode” selected illustrating a user in San Francisco who is leaving their hotel 601, the Intercontinental San Francisco at Howard & 5th Street, at 11 am and needs to get to Pier 33 607 by 1:15 pm in order to catch the 1:30 pm ferry to Alcatraz Island National Park. The user departs their hotel 601 and selects “Tourist Mode” as their route preference. They are then instructed to walk East on Howard Street 601 to the bus stop at 3rd & Howard Streets 603. This leg of the route takes 7 minutes. At the bus stop 603 they are instructed to board the arriving Northbound #8 bus, which will travel along 3rd Street and Kearny Street 604, and then exit the bus at Pacific Ave & Columbus Ave 105. This leg of the route takes 10 minutes. From Pacific Ave & Columbus Ave 605 they are then directed on a leisurely 1 hr 45-minute walk 606 through the historic North Beach neighborhood enjoying tourist sites such as the Transamerica Pyramid 608, St. Peter & Paul's Cathedral at Washington Square 609 and Coit Tower 610. During this walk the user also chose to stop for coffee on Stockton Street 611 and the remaining walk was adjusted so that they would arrive at Pier 33 607 by 1:15 pm in order to catch the 1:30 pm ferry to Alcatraz.

A user's valence/arousal sentiment, their emotional reaction based on what they are seeing and experiencing, including food, on a journey could be entered by the user or somehow sensed by a wearable device such as an Apple watch or a Fitbit that monitors a user's vitals. The level of valence, the more they enjoyed viewing a particular site or experience, would be logged into their profile and they would be shown similar items on future trips. For example, they particularly enjoyed St. Peter and Paul's cathedral in the example above. This could result in the system routing them to old churches and cathedrals and other notable religious architecture when on future journeys designed by the system. Perhaps the system may automatically update the present journey based on the valence input and they would be shown similar items, if any existed, on their route to Pier 33. This may result in the route and/or the methods of transit being altered by the system. For example, they may then be directed to board a hop-on-hop-off tourist bus that was on the way to the more modern but equally famous Cathedral of St. Mary. They could then take the hop-on-hop-off all the way back to Pier 33 in time for their ferry to Alcatraz.

A further example is one where the user described above, going from their hotel to Alcatraz, may also be going to the Giants game that evening. In essence these are two separate trips, one from the Hotel to Alcatraz requiring an arrival by 1:15 PM and the next from Alcatraz to AT&T park requiring an arrival by 7:15 PM. A day with several trips, each with their own set of modifiers could be planned. These could also be modified along the route or as the day progressed or environmental factors, such as rain, a delay in a selected transit option or traffic, etc. could necessitate change in the route or time allowed for interests along the way.

Our next example is of a traveler who wishes to go from Palo Alto, Calif. to San Francisco for a meeting at 5 PM. When requesting their route, they check train in the transit method modifier since they dislike busses, especially on longer trips. The system gives them directions to take Caltrain from the Palo Alto Station on Alma Street and University Avenue to the San Francisco station at 4th and King Streets. The system also checks for events that may have an impact on ridership for the train that day and flags a Giants baseball game at AT&T Park, located in close proximity to the 4th and King stop, as a guaranteed source of extra ridership for trains that day. It's now noon and even though the game is at 7:15 pm any train after 3 pm may be overcrowded and the rider is directed to take an earlier train if they would like a seat or a less crowded train. They may also be informed that there is no bar or café car on Caltrain and be directed to a source for food or drink on their way to the station, such as the 7-11 on Lytton and Waverly a few blocks from the Palo Alto station, if they indicate they would like some refreshments for the journey.

The next example of the system in use is one where the route may be non-linear. Routes may be non-linear in nature such as a scavenger hunt. For the scavenger hunt example the user may need to get to a destination by a certain time and opt into a game they can play along the way. The game will take into account the need for the user to arrive at the destination at a certain time and customize the game to meet this end. If a user is stumped on finding an object, the game may offer assistance and clues to ensure that the game does not take too long. While moving from point to point the user of the system, guided by their mobile phone or other mobile device, may backtrack on their own path dependent on the priority of the activity and its importance to the game. In other words, they may find themselves going over the same street, path, bus route, etc. to facilitate the game play. If the scavenger hunt involves shops or places with opening hours, then the sequence of locations will be put into game play on a priority basis to ensure the time of the game does not run too long. Hours of operations for locations may influence this sequence. Part of the game play may also prohibit the user from doubling back or going over the same path.

A further example of the system in use is one where there are multiple parties on the same trip with the same starting point and with the same destination and arrival time. It may be that more than one person or a group is on the same route and the system may weigh each user's interests and preferences and create a unique experience that may satisfy all or most of the participants. Or perhaps each user goes on their own route as long as they make destination in time and meet the other users. For example, two people are on their way to dinner at Union Square in San Francisco and they are staying at the Hyatt near Fisherman's Wharf. Both don't mind a bit of walking along the way to their 7 PM reservation and one has indicated that they are interested in Architecture and the other has indicated they are interested in Local History. The system would build an itinerary considering both user's preferences. These may be based on a profile the user has previously created and is considered for all their journeys (This may be the case for all examples contained herein). They indicate they would like to leave at 5 PM giving them two hours for their trip. They are directed by their phone or other mobile device to walk up Columbus Ave., being shown St. Peter and Paul's Cathedral, the Firemen's Memorial Statue donated by Lillie Hitchcock Coit, of whom the famous Coit tower is named after, in Washington Square Park, City Lights Books and a view of the two Transamerica buildings from the corner of Broadway and Columbus outside of City Lights books. They are then directed to walk west on Broadway to Stockton St and board the 8 bus heading south that is due in five minutes. This will take them to the Sutter and Stockton stop and a further one block walk to Union Square to arrive in time for their reservation at the Cheesecake Factory overlooking Union Square. Both users of the system have had their interests met to a certain extent and seeing as Architecture and Local History are closely entwined the journey was an enjoyable one for both parties. In another instance, it may be that the desired interests and modes of transit are so different that the system devises different routes and activities for each party. Each route would get all the travelers to the destination on time and allow them to have a beneficial experience tailored to their individual needs while still arriving on time. Individuals may choose to depart at different times and perhaps go directly to the destination while others experience activities and sights along the way. It may also be that there is a group that has the same destination and time to arrive, but they have differing start points. The system would calculate individual routes with individual interests and ensure all the parties arrived on time. It is also possible that members of the group meet up, i.e. were joined together by the system, along the route. The system may also take into account the familiarity that the parties have with each other. If they indicate they are good friends the system may keep those travelers together and give those who are unfamiliar with each other differing routes. The opposite may also be true so that strangers become better acquainted with each other, and it may be the case that good friends don't mind spending some time apart.

Events and environmental factors may occur that necessitate a modification to the planned route and/or activities. For example, in the case of our user on their way to the Giants baseball game in San Francisco; they could be notified of an expected one hour rain delay to the start of the game, meaning they now have until 8:15 PM to get to their destination, AT&T Park. They may decide to change their dining option from a casual fast meal to a more relaxed fine dining experience. Or perhaps they simply delay their journey's start time and due to the change in weather & decide not to walk, or to bring proper attire for the walk. A user of the system may also be notified that another party they were meeting at their destination will either be arriving early or late. This would also result in a modification to the planned journey and activities. In the case of early arrival they may decide to change a walking, and therefore slower, leg of the journey to a bus or a train. And the opposite may be the case in the event of a late arrival, or perhaps there are added activities along the way such as stopping to look at public art along a walking route. Other factors that may cause a modification to the planned journey may include a notification of an appointment cancellation, a traffic accident or transit delay, taking too much time for an activity along the route, staying to long in a museum or a meal that takes longer than expected for example, could cause the system to modulate and update the journey plan. Should the schedule of activities either advance or delay the system would recalculate and provide updates to the recommended trip plan. The time element for the activity may also be modulated or informed by the transit mode characteristics and/or schedule. For example, a user who is at a stop in a museum along their journey may be informed that their next transit leg, a bus, is delayed. The system updates and books a car service to finish the last leg of the journey. Since the car service will take less time than the original bus leg, the user is given more time to enjoy the museum. Again, while engaging in activities along their journey the system may provide alerts about time left for a specific activity, and updated arrival time of trains and busses.

It may be that as part of a user's profile they have a list of errands, tasks and activities they need to accomplish and the system would be able to create a journey where one or more of these tasks could be completed. It may be that these are done on more day to day trips such as going to and from work etc. It may also be the case that somebody on holiday may have errands such as buying postcards, or needing to pick up sunscreen or some other essential to their stay. For example, we have a user who has “haircut” as one of their errands and they are on their way home from work at 5 PM. They need to be home for dinner by 6:30 so the system could calculate a journey that would take them by their usual barber shop, or perhaps a new one that was offering a coupon and get them home in time for dinner. They may be directed to take a subway to grand central station, even though this is not their normal route home, and disembark their train, exit the station through the southeast exit and walk east on 41nd St. for two blocks to Midtown Barbers (the system may have made a reservation to coincide with the arrival time of their train) where they receive their haircut and redeem a coupon provided by the system. Once their haircut is completed, they are directed back to grand central station where they are directed to board a subway that will get them home in time for dinner at 6:30. Other errands, task or activities could include but are not limited to; Dropping off or picking up a prescription, Shopping, Dropping off or picking up dry cleaning and laundry, Haircut, Shoeshine, Seeing a movie, Exercising, ATM and Banking.

As mentioned checking off the list of errands and tasks to be completed most likely would be added by the system into everyday journeys when the user finds themselves going to everyday destinations such as but not limited to: My School, My Office, My Gym, My Pharmacy, My Coffee shop, My Dog walking paths, My Running paths, My Bank, Favorite Bar.

Having these set up in My preferences will inform the system for transit and timing recommendations when one wished to complete a selected errand, task or activity during a journey.

Users of the system may find themselves wishing to go to the same destination in roughly the same amount of time from the same starting point but wish to take a different, non-repeat journey, perhaps with different methods of transit, or different attractions and interests, and perhaps even a different route entirely. For example, we take our previous user in San Francisco who was traveling from their hotel to Alcatraz. They had such a good experience at Alcatraz that on their next visit to San Francisco they wish to visit the island again. They have booked the same Ferry for 1:30 PM, needing to arrive at 1:15 PM and are again leaving from the same hotel at 11 AM. They select the non-repeat journey function, leaving tourism as their preferred on-route activity, and are offered two different routes; one via the Embarcadero and the historic F street car and a stop at the Exploratorium museum, and the other over Nob Hill via Cable Car. Each route provides the user with proper arrival time and fulfils their desire to see new tourist attractions along the way. It may also be the case that the user likes the original route and selects a different modifier for their interests along the way. For their second journey, they select art and public art. Once they get to North Beach they are guided to view murals, statues and sculptures along the walk to Pier 33.

A further example can be shown by two users who are on vacation in Portland Oreg. They are staying at a hotel near Pioneer Place downtown. It is 10:30 AM and they need to meet some friends at the Oregon Museum of Science and Industry (OMSI) across the Willamette river in 40 minutes. They both also inform the system that want to see the new Tilikum crossing bridge on the way. The bridge is just South of the OMSI. They both also have biking, but only in non-crowded and less busy streets, as one of their preferred methods of transit in their user profiles. They are directed to leave their hotel at 6th and Morrison downtown and walk south on 6th St. to Pioneer Courthouse MAX light rail stop and take the Orange line south for 13 minutes to the South Waterfront station on the west end of Tilikum Crossing. Here they are directed to one of the BIKETOWN bike-share kiosks (the kiosks dot the city of Portland) located at the west foot of the bridge. The bridge does not allow car, just light rail, busses, pedestrians and bikes so it will be a very pleasant and non-crowded ride over the bridge. They rent the bikes and have a leisurely ride across the beautiful bridge, perhaps stopping to snap a few photos, and are then directed to return the bikes to the BIKETOWN kiosk located at the east foot of the bridge upon their arrival. After returning the bikes they are then instructed to take a short walk north along the bank of the Willamette river to the OMSI in time to meet their friends.

Users may also inform the system that they prefer crowded or quiet routes, perhaps just for walking portions of a journey. Data about the amount of people on a given street could be determined by several means, just general knowledge that some streets, like Market St in San Francisco, are heavily trafficked by pedestrians almost all the time. It is also possible to glean crowd data from smart street lamps that are being deployed increasingly in cities around the world. These smart street lamps are equipped with a sensor pack with capabilities such as video, light and weather sensors. This way a user who had requested a non-crowded route will be guided by the system down quiet less traveled streets. It may also be the case that time of day may dictate a change to their request for safety reasons and after dark they would be directed to utilize more trafficked streets for safety. Crowded and non-crowded route requests may also dictate what bus to board, or perhaps even what car on a train to board that had seats available.

Adding an element of meeting people, friends or friends of friends on a journey may also be appealing. With people being able to check into establishments on social media one could add a “meet friends” option to a journey. Take the example of our user in San Francisco going from their hotel to Alcatraz. They may activate the “friend” mode for the journey and if friends checked in near to the route of the journey the user may choose to be guided to meet them along the way, or perhaps suggest an alternate place to meet up for a coffee, drink or a meal along the route, all the while keeping in mind the time element an need to arrive at pier 33 at 1:15 for the ferry. Another possibility s that the user might set up automatic check ins to places they stopped at along the route so their social media networks could follow along on their journey from afar.

Once completed, any of these routes could be saved as a favorite route by the user and if they found themselves needing to get to the same destination from the same starting point in the same amount of time they may choose to take the exact same journey again.

Given the examples illustrated above it may now be appreciated that a trip from origin to destination need not always be the fastest or most direct but may also be modified by other factors as described in order to take advantage of, for example, the time available and/or access to local points of interest. A user of the system may be able to make a trip more enjoyable or fulfilling while still arriving at the desired destination on time. In addition, a user of the system may potentially set up a user profile to inform the system as to their preferences, limitations, interests etc. and the system may be configured to, over time, modify or add to the user's profile based upon the usage of the system by the user. Also, the system may be configured to allow a user of the system to make reservations, purchase tickets, etc. via various already existing portals related to each point of interest along the route.

While on journey the users of the systems described herein may take advantage of such technologies as Augmented Reality and Pointing Search, both utilizing the real-world position and pointing direction of a mobile device derived through GPS (or other positioning means) and the electronic compass and gyroscopes that are part of standard hardware on most mobile devices, to be guided and access information about their surroundings.

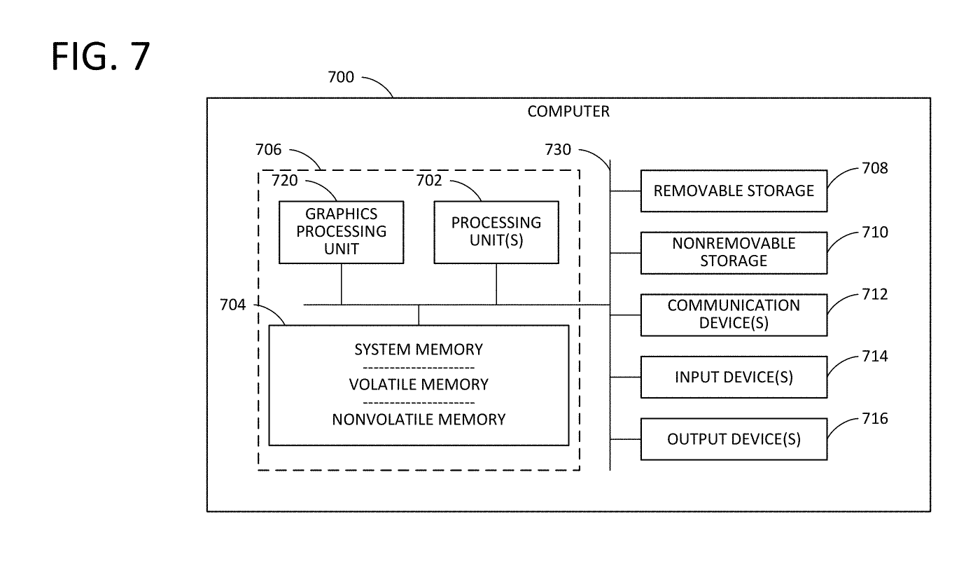

FIG. 7 illustrates an example computer 700. Components of the embodiments disclosed herein, which may be referred to as modules, engines, processes, functions or the like, can be implemented by configuring one or more instances of the example computer using special purpose software or applications, possibly in different configurations and optionally networked, as a computer system. The computer 700 can be any of a variety of general purpose computers such as, for example, a server, a desktop computer, a laptop computer or a mobile computing device.

On a general purpose computer, a processor typically executes computer programs which include an operating system and applications. The operating system is a computer program running on the computer that manages access to various resources of the computer by the applications and the operating system. The various resources generally include memory, storage, communication interfaces, input devices and output devices. Any of the methods disclosed herein can be implemented using computer readable code, stored on memory of the computer 700 and executed by a processor of the computer, while accessing various components of the computer as necessary.

With reference to FIG. 7, the example computer 700 includes at least one processing unit 702 and memory 704. The computer can have multiple processing units 702 and multiple devices implementing the memory 704. A processing unit 702 can include one or more processors or processing cores (not shown) that operate independently of each other. Additional co-processing units, such as graphics processing unit 720, also can be present in the computer. The memory 704 may include volatile devices (such as dynamic random access memory (DRAM) or other random access memory device), and non-volatile devices (such as a read-only memory, flash memory, and the like) or some combination of the two. This configuration of memory is illustrated in FIG. 7 by dashed line 706. The computer 700 may include additional storage (removable and/or non-removable) including, but not limited to, magnetically-recorded or optically-recorded disks or tape. Such additional storage is illustrated in FIG. 7 by removable storage 708 and non-removable storage 710. The various components in FIG. 7 are generally interconnected by an interconnection mechanism, such as one or more buses 730.

A computer storage medium is any medium in which data can be stored in and retrieved from addressable physical storage locations by the computer. Computer storage media includes volatile and nonvolatile memory devices, and removable and non-removable storage media. Memory 704 and 706, removable storage 708 and non-removable storage 710 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 700 may also include communication device(s) 712 through which the computer communicates with other devices over a communication medium such as a computer network. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals.

Communications device(s) 712 can include, for example, a network interface or radio transmitter, that interface with the communication media to transmit data over and receive data from signals propagated through communication media. The communication device(s) 712 can include one or more radio transmitters for telephonic communications over cellular telephone networks, and/or wireless connections to a computer network. For example, a cellular connection, a Wi-Fi connection, a Bluetooth connection, and other connections may be present in the computer. Such connections support communication with other devices, such as to support voice or data communications.

The computer 700 may have various input device(s) 714 such as a keyboard, mouse, touchscreen and pen, image input devices, such as still and motion cameras, audio input devices, such as a microphone, and various sensors, such as accelerometers, thermometers and magnetometers. Output device(s) 716 such as a display, speakers, printers, and so on, also may be included.

The various storage 710, communication device(s) 712, output devices 716 and input devices 714 can be integrated within a housing of the computer, or can be connected through various input/output interface devices on the computer, in which case the reference numbers 710, 712, 714 and 716 can indicate either the interface for connection to a device or the device itself as the case may be.

An operating system of the computer typically includes computer programs, commonly called drivers, that manage access to the various storage 710, communication device(s) 712, output devices 716 and input devices 714. Such access generally includes managing inputs from and outputs to these devices. In the case of communication device(s), the operating system also may include one or more computer programs for implementing communication protocols used to communicate information between computers and devices through the communication device(s) 712.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A computer system may be practiced in distributed computing environments where operations are performed by multiple computers that are linked through a communications network. In a distributed computing environment, computer programs may be located in both local and remote computer storage media.

Each component of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Components of the embodiments disclosed herein, which may be referred to as modules, engines, processes, functions or the like, can be implemented in hardware, such as by using special purpose hardware logic components, by configuring general purpose computing resources using special purpose software, or by a combination of special purpose hardware and configured general purpose computing resources. Illustrative types of hardware logic components that can be used include, for example, Field-programmable Gate Arrays (FPGAs), Program-specific Integrated Circuits (ASICs), Program-specific Standard Products (ASSPs), System-on-a-chip systems (SOCs), and Complex Programmable Logic Devices (CPLDs).

Although the subject matter has been described in terms of certain embodiments, other embodiments, including embodiments which may or may not provide various features and advantages set forth herein will be apparent to those of ordinary skill in the art in view of the foregoing disclosure. The specific embodiments described above are disclosed as examples only, and the scope of the patented subject matter is defined by the claims that follow.

In the claims, the term “based upon” shall include situations in which a factor is taken into account directly and/or indirectly, and possibly in conjunction with other factors, in producing a result or effect. In the claims, a portion shall include greater than none and up to the whole of a thing; encryption of a thing shall include encryption of a portion of the thing. In method claims, any reference characters are used for convenience of description only, and do not indicate a particular order for performing a method.

1. A method for generating a travel route, the method comprising:
receiving a travel routing request, wherein the request comprises a specification of a destination and an arrive by time or maximum travel duration;
determining a starting location;
querying a database of locations to identify a candidate set of one or more intermediate stop locations;
for each of a plurality of combinations of one or more of the set of intermediate stop locations, and
for each of one or more permutations of the each combination of one or more intermediate stop locations:
determining a route from the starting location to the destination, passing through the permutation of the each combination of one or more intermediate stop locations,
determining a predicted arrival time or a predicted duration for traversing the route,
comparing the predicted arrival time to the arrive by time or comparing the predicted duration to the maximum travel duration, and
determining whether to present the permutation in a user interface based on the comparison.

2. The method of claim 1, wherein the predicted arrival time or duration for traversing the route accounts for stopover times at the one or more intermediate stop locations.

3. The method of claim 1, wherein the database is queried based on a saved user profile.

4. The method of claim 3, wherein the saved user profile specifies a set of one or more location preferences, and wherein the database is queried based on the one or more location preferences.

5. The method of claim 3, wherein the saved user profile specifies a set of one or more transit type preferences, and wherein the route is determined based on the set of one or more transit type preferences.

6. The method of claim 1, wherein the travel routing request comprises an arrive by time, wherein the determining is of a predicted arrival time, and wherein the comparing is of the predicted arrival time to the arrive by time.

7. The method of claim 6, wherein the comparing the predicted arrival time to the arrive by time comprises determining whether the predicted arrival time is earlier than the arrive by time by at least a predetermined threshold.

8. The method of claim 6, further comprising determining a start time, wherein the determining a predicted arrival time is based on the start time.

9. The method of claim 8, wherein the travel routing request further comprises a specification of the start time.

10. The method of claim 1, wherein the travel routing request further comprises a specification of the starting location.

11. The method of claim 1, wherein the travel routing request comprises a maximum travel duration, wherein the determining is of a predicted duration, and wherein the comparing is of the predicted duration to the maximum travel duration.

12. The method of claim 11, wherein the comparing the predicted duration to the maximum travel duration comprises determining whether the predicted duration is less than the maximum travel duration by at least a predetermined threshold.

13. The method of claim 11, further comprising determining a start time, wherein the determining a predicted duration is based on the start time.

14. A method for generating a travel route, the method comprising:
receiving a travel routing request, wherein the request comprises a specification of:
a travel time specified by at least two of:
a start time,
an arrival time, and
a travel duration, and
a destination location;
determining a starting location;
querying a database of locations to identify a candidate set of one or more intermediate stop locations;
for each of a plurality of combinations of one or more of the set of intermediate stop locations, and
for each of one or more permutations of the each combination of one or more intermediate stop locations:
determining a route from the starting location to the destination, passing through the permutation of the each combination of one or more intermediate stop locations,
determining a predicted arrival time or a predicted duration for traversing the route,
comparing the predicted arrival time to the arrival time or comparing the predicted duration to the travel duration, and
determining whether to present the permutation in a user interface based on the comparison.

15. The method of claim 14, wherein the travel routing request further comprises a specification of the starting location.

16. The method of claim 14, wherein the determining a predicted duration is based on the start time.

17. The method of claim 14, wherein the arrival time is a desired latest arrival time.

18. The method of claim 14, wherein the travel duration is a desired maximum travel duration.

19. The method of claim 14, wherein the database is queried based on a saved user profile.

20. The method of claim 19, wherein the saved user profile specifies a set of one or more location preferences, and wherein the database is queried based on the one or more location preferences.
